(19) United States
(12) Patent Application Publication
(10) Pub. No.: US 2024/0095773 A1
(43) Pub. Date: Mar. 21, 2024

(54) SYSTEM AND METHOD FOR CREATING CRYPTOGRAPHIC ASSETS THAT DESCRIBE CONTENT-DISPLAY RIGHTS FOR THE HOLDER AND THE USE AND EXCHANGE THEREOF

(71) Applicant: John Davenport, Draper, UT (US)

(72) Inventor: John Davenport, Draper, UT (US)

(21) Appl. No.: 18/526,932

(22) Filed: Dec. 1, 2023

Related U.S. Application Data
(60) Provisional application No. 63/592,153, filed on Oct. 21, 2023.

(51) Int. Cl. G06Q 20/38

(52) U.S. Cl. CPC G06Q 20/389; G06Q 20/3825

(57) ABSTRACT

A computer program product, system, and computer-implemented method for facilitating rights management of NFTs associated with a digital advertising space on a website. The NFT is defined, in some embodiments, by a tree data structure comprising site specification information including the boundaries of a web advertising area on the website to which the NFT entitles a borrower to serve content on the website, from a CDN in some embodiments. The NFT may be embodied as a distributed ledger or blockchain. A host system creates the NFT and prompts a user to define the web advertising area using a visual editor in some embodiments.

### BACKGROUND OF THE INVENTION

### Field of the Invention

The present invention relates generally to a method of displaying a digital image on a promotional property.

### Background

Revenue Generation through Website Advertising.

Website proprietors can generate revenue by selling space for advertisements. These site owners employ various strategies to optimize their earnings through ad display. The ensuing strategies are commonly employed:

Ad Servers: Technological solutions known as ad servers are utilized to manage and regulate the delivery of advertisements on a website. These servers monitor impressions, clicks, and other pivotal metrics to enhance ad performance. Additionally, they facilitate targeting, ensuring that ads are directed toward the appropriate audience.

Programmatic Advertising: This entails the automated procurement and sale of online advertising. Automation streamlines transactions and enhances efficiency by consolidating digital advertising activities into a single technological platform. Algorithms are employed to secure real-time advertising space purchases, considering factors such as demographics, browsing habits, and user interests to display the most pertinent ads.

Ad Network Collaborations: Websites, like ESPN, may establish partnerships with third-party ad networks, such as Google AdSense, which manage ads from diverse advertisers. These networks employ intricate algorithms to match ads with websites and specific content where they are most likely to yield success, based on accumulated data.

Direct Advertisement Sales: Certain portions of ad space can be directly sold to advertisers. This typically involves an in-house sales team collaborating directly with brands and agencies. Such transactions often encompass high-value placements or sponsorships.

Data Management Platforms (DMPs): These tools collect, analyze, and manage data from various sources to enhance ad targeting. For example, ESPN might employ a DMP to analyze its audience data and segment it into distinct groups based on interests, demographics, etc.

Dynamic Ad Insertion (DAI): This technology enables real-time swapping of ad content, delivering different ads to diverse users based on an array of factors.

Ad Operations Team: Prominent companies like ESPN generally maintain dedicated Ad Operations teams responsible for the technical configuration, execution, and optimization of digital advertising campaigns.

Native Advertising: These are paid ads seamlessly integrated into the look, feel, and functionality of the host media format. They are designed to be less intrusive than traditional ads.

These systems synergistically manage ad content to ensure precise targeting, optimizing relevance, efficiency, and ultimately, profitability. Major websites periodically assess their existing methodologies, adapting to new technologies, market trends, and user behaviors. Notably, altering Ad Display methods is often hindered by inherent inefficiencies related to coding changes, contract reviews, and payment processing. The present invention eliminates these inefficiencies, enabling real-time pricing and ad swapping for any website's advertising space.

### DESCRIPTION OF THE RELATED ART

Blockchain

A blockchain is a decentralized ledger that operates without a single point of failure. It possesses the capacity to store identifying digital data, such as ad space identifiers and ad image file locations.

Blockchain Address

Each Non-Fungible Token (NFT) is linked to a distinct blockchain address. These addresses typically comprise 64 alphanumeric characters, ensuring their uniqueness and enforceability within the blockchain network.

NFTs

Non-fungible tokens (NFTs) are specialized blockchain records exclusively owned by a single bearer at any given time. NFTs can be transferred between bearers via their digital wallets.

Smart Contracts

Digital agreements, represented by computer code, regulate NFT holder transfer and payment schedules.

Ad Image API

Websites utilize Application Program Interfaces (APIs) to request information from external programs or within their own code services.

QR Code

A distinct, visible image that connects real world print or digital media with digital content.

### SUMMARY OF THE INVENTION

Described herein is an NFT digital asset referred to as an “Ad Locker”, which provides the holder of the NFT display rights to display their images on promotional space. An NFT ID and Ad Locker ID are used herein interchangeably. Furthermore, when referencing an NFT in context of digital promotional space that term is also interchangeable with Ad Locker.

An Ad Locker Creator is the person or entity that is the real-world owner of digital promotional space such as a billboard, digital display banner, web site, or mobile app. An Ad Locker Holder is the person or Entity that controls the images and user actions associated with that digital promotional space.

The Ad Locker Smart Contract describes the rules by which an Ad Locker Creator allows control of their digital promotional space. The contract can include image limitations and maturity level, destination restrictions, resale fees or periodic service fees. Any real-world contract feature can be present in the smart contract.

Leveraging distributed ledgers marketers can exchange Ad Lockers with each other without direct involvement from the Ad Locker Creator and without fear of payment default or the burdens of time restrictions that current methodologies employ.

The design considers “near real time” to be a timeframe less than 15 minutes, however, some blockchains are considerably faster in their transaction confirmation times with some taking more seconds to complete.

The design considers that in some examples, the advertising space may be: a website banner ad; a digital billboard on a highway; an LED display on a celebrities hat, an AI rendering of a soda can within a movie; the LED logo on the side of a professional player's tennis shoe; the digital rendering of an ad on a football field; the digital rendering of an ad on a players jersey; an endorsement avatar; or other such display methods designed to provide an audience with an image or information that promotes a product, idea, political party, thought, individual, et cetera. There is no restriction of this design in the type of digital advertising content in which this invention applies. If a digital space has monetary value for the purpose of promotion, Ad Locker provides a monetary benefit for the party that controls that digital space.

For all embodiments, digital display mediums display marketing images via a digital asset identified by an Ad Locker ID and method of connecting the real-world ad medium with characteristics of the Ad Locker stored in the blockchain. Changing the ownership of the digital asset will result in the near immediate switch of real-world display behavior.

The Ad Locker Smart Contract terms are transparent within the blockchain. Any party may review the terms and engage in an exchange of the asset based on those publicly available terms.

Ad Locker requires a server class computer Image Server enumerated by the new Ad Locker holder in the blockchain. The Image Server provides the actual images and other asset characteristics to the Ad Locker Creator and those images and characteristics are transferred to the website in the corresponding digital promotional space. The Image Server is designed to serve images with other ad-relevant characteristics such as a click-through website destination.

Ad Locker APIs use the Ad Locker ID as the primary identifier for querying the blockchain, buying and selling Ad Locker assets and viewing NFT holder history.

The summary is not intended to describe all embodiments or every aspect of the invention. Digital marketing is a diverse field with many permutations of digital image targeting a particular audience. Each medium, audience, variation of digital marketing may customize their Ad Locker implementation to accomplish their specific revenue objectives.

This invention also does not attempt to change or impact contract law in any way. The Ad Locker Smart Contract can easily be terminated, revised and rewritten with the mutual agreement of the current contract holder and the Ad Locker Creator as is the case with most any contract.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a view of digital promotional space represented by data records in a distributed database. The data describes attributes controlled by the site owner and attributes controlled by the NFT holder;

FIG. 2 is a diagram of a website, which is a common use of digital promotional space;

FIG. 3 is a diagram of the process by which Ad Locker NFTs are minted creating an Ad Locker ID and a corresponding Creator Record ID;

FIG. 5 is a diagram of how a website accesses the blockchain with an Ad Locker ID and retrieves the corresponding image from the current Holder's image server;

FIG. 6 is a display screen revealing a summary of Ad Locker SmartContract attributes;

FIG. 7 is a representation of a digital product placement where the soda can is CGI rendered within a video game, movie, or podcast. Pausing the video reveals the QR code in the bottom corner of the screen;

FIG. 8 describes how trading software protocols query the blockchain for information necessary to facilitate a trade between two parties for an existing Ad Locker NFT. The creator is a passive party to future exchanges; and

FIG. 9 is a representation of a live sporting event where the digital advertising medium is the banner below a boxing ring with a digital image and QR code in the corner. The advertisement and QR code are viewable by spectators.

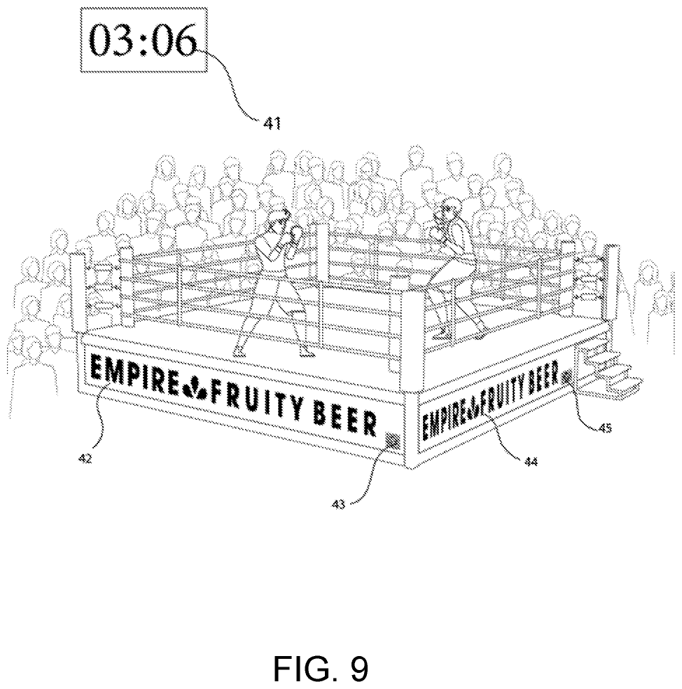

### DETAILED DESCRIPTION OF THE INVENTION

D

Defining Digital Promotional Space Contract and Display Parameters

The examples provided herein are meant to describe the novelty and nature of this invention but not to restrict the use of this invention to provide competitive advantage in any digital advertising market.

For the purposes of the detailed description: the use of “actionable visual cue” includes clickable actions such as check boxes, action corners, clickable icons, mouse-over, pop up windows, hover action, QR code, bar code or any of the variants used to display more information to an end-user in context of what the user is viewing.

For the purposes of the detailed description: “blockchain” and “distributed ledger” refer to any decentralized network where a shared ledger has no outside, single-party control. All updating and broadcasting parties validate new entries through proof of work, proof of stake or other mechanism by which participating miners or ledger updating services solve the famous byzantine general problem of how to trust competing parties.

The features provided herein remove inefficiencies in how content control of advertising space changes between two competing parties. Due to the analog nature of our world in the past 100 years almost all advertising contracts are written in documents, often printed, approved by management and legal teams, and involve a contract date beginning some moment in the distant future (a day or many months.) Implied by these inefficiencies, legacy advertising methodologies gift control, and financial benefit to the current marketer at the expense of the promotional space owner.

The Ad Locker is a digital file that represents all real-world attributes of a digital promotional space such as a web page as well as the real-world display restrictions found in any real-world marketing contract between a marketer and a promotional space owner. These restrictions can be on image quality and content and are typically enforced with third party software. Unlike legacy marketing and promotional space agreements, Ad Locker agreements can are transparent on the blockchain and new purchases can buy promotional space without registration or time consuming engagement with the promotional space owner.

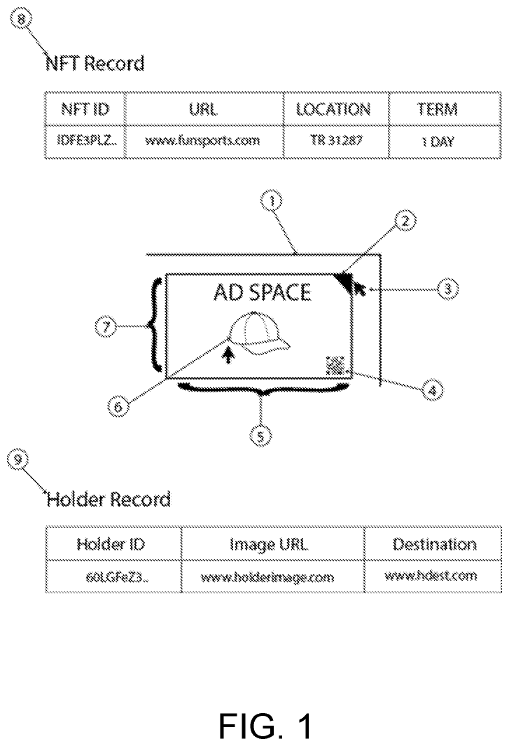

The AD Locker blockchain record stores real world attributes as an NFT Record FIG. 1 positions 1-7 including location, actionable queues, dimensions and contract conditions. These attributes are defined by the Ad Locker Creator. These attributes are saved as an owner record FIG. 1 position 8 and som attributes can be manipulated by the current NFT holder such as their target location. Ad Locker records are unique in that they link the real world display space with a digital owner. They are linked by and Ad Locker ID and a Holder ID, FIG. 1 position 8 and 9.

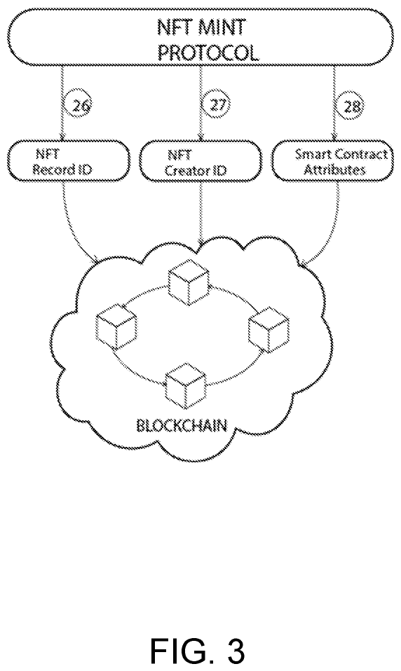

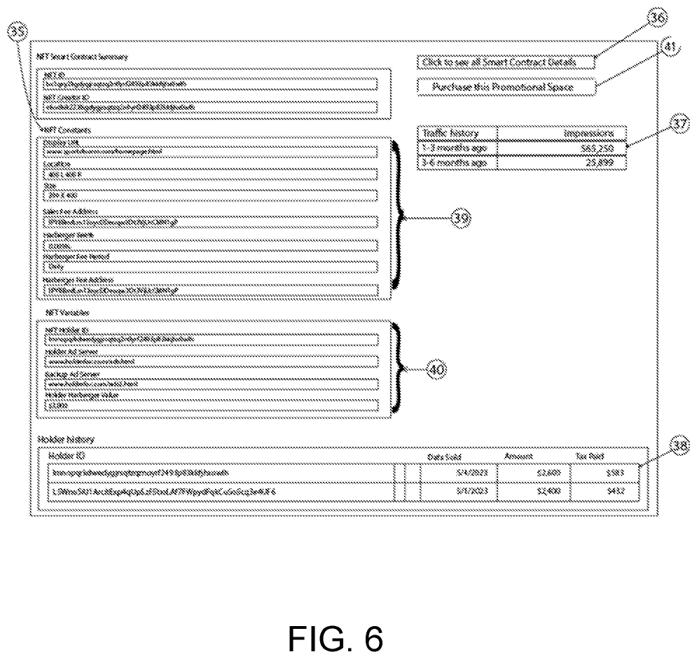

The Ad Locker Mint Protocol creates the NFT in the blockchain and includes the attributes defined by the Ad Locker Creator. These Smart Contract Attributes FIG. 3 position 28 become part of the NFT record. These details are publicly visible to anyone that queries the blockchain FIG. 6.

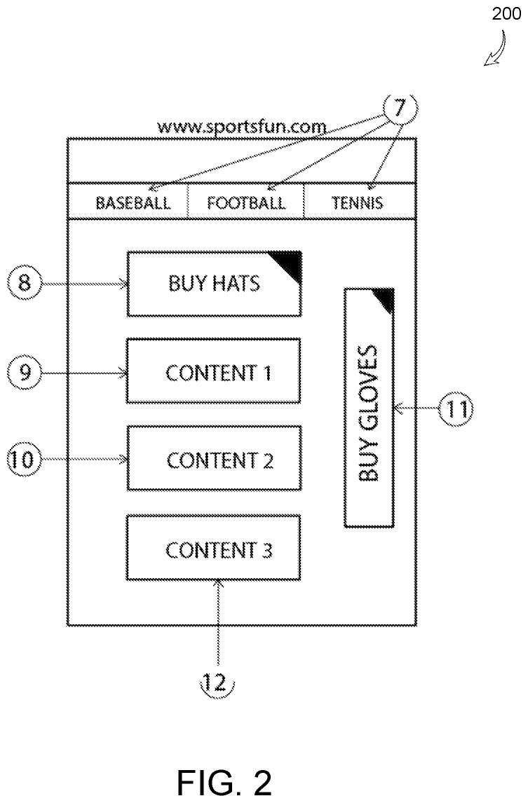

The Ad Locker Creator may be a website owner where several advertisements are present on each web page FIG. 2 positions 8 and 11. Each promotional image can be converted to an Ad Locker. The website runs the Ad Locker Image Protocol to retrieve NFT asset characteristics from the blockchain and the Ad Locker Holder's Image Server, FIG. 2 positions 8 and 11.

Websites contain many images that are not sold as promotional space, FIG. 2 positions 7, 9, 10, 12.

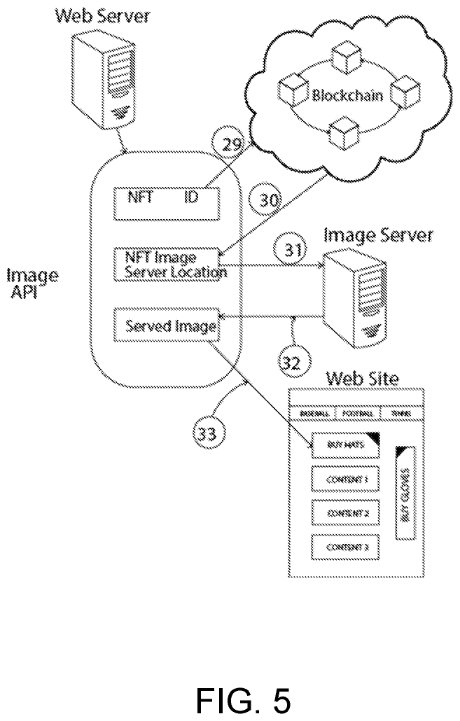

Ad Locker NFT records store data elements necessary to run the Ad Locker Image API and serve an advertising image on behalf of the Holder. FIG. 5 describes the Ad Locker API that retrieves an image file, position 32, by requesting details from the Holder Image Server at position 31. The Blockchain provides details to the information about the Holder 30, which is available by providing the AdLocker ID in a blockchain query 29.

Ad Locker NFT records store data elements necessary to run the Ad Locker Image API and serve an advertising image on behalf of the Holder. FIG. 5 describes the Ad Locker API that retrieves an image file, position 32, by requesting details from the Holder Image Server at position 31. The Blockchain provides details to the information about the Holder 30, which is available by providing the AdLocker ID in a blockchain query 29.

Ad Locker NFT records store data elements necessary to run the Ad Locker Image API and serve an advertising image on behalf of the Holder. FIG. 5 describes the Ad Locker API that retrieves an image file, position 32, by requesting details from the Holder Image Server at position 31. The Blockchain provides details to the information about the Holder 30, which is available by providing the AdLocker ID in a blockchain query 29.

This embodiment describes the novelty of being able to sell promotional space real time as the true value of that promotional space can change dramatically during a sporting event. Unique circumstances can create viral moments. Fan engagement or historical significance cannot be fully priced into the original advertising agreement because those pricing considerations are merely speculation. However, as the event is unfolding those valuations become clear and monetizable. That monetization is completely lost with the legacy advertising pricing model and gifted to marketers at the expense of the Promotional Space Owner.

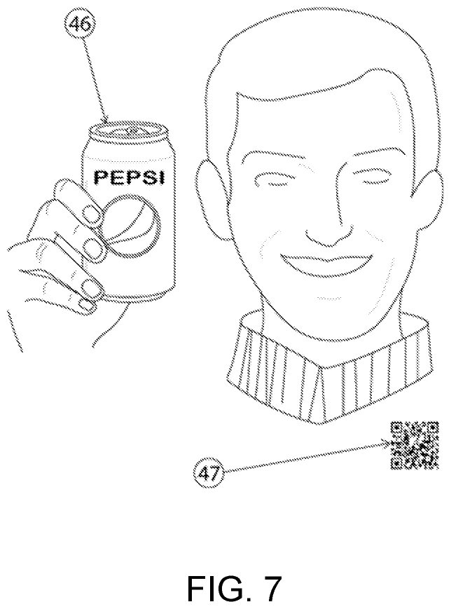

In another embodiment the advertisement is a digital rendering of a popular soda from a single frame in a movie or short internet video FIG. 7. The soda is entirely digitally rendered with CGI and the rights to place that soda in the movie were sold long before the movie or video was published. In legacy marketing agreements, the content creator gifts viral video upside to the marketer.

With Ad Locker, pausing the video would display a QR code in the bottom left, which a marketer can scan and access the Ad Locker SmartContract screen, FIG. 6 or similar, for any Ad Lockers visible in that frame. That digital image can then be purchased by a new marketer, if the price and contract terms are agreeable. Upon execution of the SmartContract the video would immediately change the soda to the image the new Ad Locker Holder specified for that single frame and the entire video.

Again this embodiment explains the analog nature of existing advertising contracts. Often movies like the Blair Witch Project exceed the wildest expectations of the content creator. Ad Locker enables Creators to monetize the value of their promotional space as the value of their promotional placement increases.

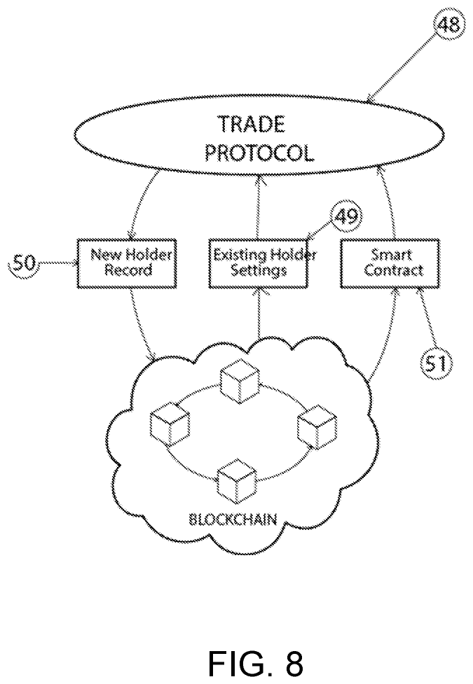

In all embodiments, the exchange of Ad Locker assets is governed by common distributed blockchain protocols, security, and computer networks. With Ad Locker NFTs the trade of an asset is determined by the prospective buyer providing cryptographics funds to fulfill the Ad Locker Smart Contract FIG. 8, position 51. After providing funds, common blockchain payment transactions APIs transfer control from the current holder to the new Ad Locker holder FIG. 8 position 50. This exchange happens without the Ad Locker creator's involvement.

The Smart Contract provides numerous capabilities on the public ledger, such as identifying the current holder and the amount of fees paid to the Ad Locker Creator.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims.

Additional features may be reflected in the following clauses:

Clause 1: A method of connecting digital advertisements to digital promotional space purchase agreement through QR Code, clickable icon, visual cue providing machine readable, device access to promotional space details and contract agreements and blockchain transaction initiation.

Clause 2: A method for connecting real world digital promotional assets to the blockchain, through actionable visual cues such as icons, action corners, QR codes.

Clause 3: A method for compensating social media influencers with a continuous revenue stream from product or personal endorsements on their profile page.

Clause 4: A method for displaying digital promotional space details and purchasing options directly from the digital promotional space itself.

Clause 5: A method for transferring control of digital promotional space in near real time without complex network registration including traditional banking or third-party membership requirements.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for automating generation of cryptographic digital assets associated with digital promotional space including the location, user interaction and payment contract, comprising:
transfer of display control as defined by digital contract details from one asset holder to another via distributed computer systems;
determining, via digital Smart Contract the current owner and contract conditions controlling the digital promotional space via a unique Holder ID;
generating a cryptographic asset and Smart Contract that contains all elements of digital advertising space and the payment contract defined by the asset creator;
identifying both the asset creator and asset holder by unique ID entered into a cryptographic ledger.

2. The method of claim 1, wherein the asset is stored as an NFT in a distributed blockchain and modifications to the asset are facilitated by the blockchain distributed engines.

3. The method of claim 1, further comprising: Contract details accessible from the Blockchain using the NFT ID to query and display all SmartContract details.

4. The method of claim 1, further comprising validation of all exchanges by cryptographic signature in the distributed blockchain.

5. The method of displaying images for digital promotional space defined in claim 1, wherein the NFT ID identifies the image source defined in the blockchain and combined with contract rules displays an appropriate image for that digital promotional space.

6. The method of claim 5, further comprising: public transparency of all existing and previous marketing agreements and display behavior for the Promotional Space by using the NFT ID and using the blockchain as the historical record.

7. A method of exchanging digital assets using a distributed ledger, the steps of the method comprising:
moving an asset identified by an NFT ID from one party's public ID to another party's public ID;
hovering with a cursor on a display over a virtual icon to reveal contract details for promotional space digital asset.

8. The method of claim 7, wherein registration, notification, contract negotiations, payment verification, image validation are handled with blockchain integrated technology and services.
